(19) United States
(12) Patent Application Publication
(10) Pub. No.: US 2006/0138040 A1
(43) Pub. Date: Jun. 29, 2006

(54) Fuel filter with outlet openings that are preferably made by a hydroerosive process

(76) Inventor: Christoph Buehler, Gerlingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/304,643

(22) Filed: Dec. 16, 2005

(30) Foreign Application Priority Data
Dec. 23, 2004 (DE) 10 2004 062 008.3

(51) Int. Cl. B01D 35/28

(52) U.S. Cl. 210/435

(57) ABSTRACT

The invention relates to a fuel filter, which in particular comprises a rodlike filter body which can be used in a common rail system, for filtering soiled fuel before it enters an injector. The filter body has outlet openings on its circumference that are preferably produced by means of a laser process and which have rounded places, produced by a hydroerosive process, in the region of the transition from the inner wall to the outlet opening.

### CROSS-REFERENCE TO RELATED APPLICATIONS

This application is based on German Patent Application 10 2004 062 008.3 filed Dec. 23, 2004, upon which priority is claimed.

### BACKGROUND OF THE INVENTION

1. Field Of The Invention

The invention relates to a fuel filter, which is embodied in particular as a rodlike filter body and which can be introduced into an inlet conduit, in particular of a fuel injection valve of a common rail system; the filter body has at least one inlet opening and at least one outlet opening.

The invention further relates to the use of the known hydroerosive process for producing rounded places in fuel filters.

2. Description of the Prior Art

To prevent damage to fuel injection valves from contaminants in the fuel, the fuel filters known from the prior art and also known in a version as a rod filter, are typically placed in each fuel injection valve.

The rodlike filter body described in German Patent Disclosure DE 198 32 940 A1 is press-fitted into an inlet conduit of a fuel injection valve. The fuel filter itself has at least one inlet opening, through which the fuel, which is at high pressure, is introduced. Any chips and contaminants entrained with the fuel remain in the filter body, since the outlet openings have a substantially smaller diameter than the inlet opening.

Especially embodied fuel injection systems require fuel filters in which only slight pressure variations occur. The fuel filters known until now from the prior art comprise the aforementioned filter body, which has outlet openings on its circumference. Because of the constant pressure and the varying pressure pulses that are exerted by the fuel inside the fuel filter, nonlaminar flows occur, especially at the transitions from the interior of the filter body to the outlet openings. These nonlaminar flows occur particularly at the points where there is a change in cross section or a change of direction. Because of this constant stress, over the service life of the fuel filter rounded places occur at these points, so that the flow coefficient changes over the service life.

It is a prerequisite for certain fuel injection systems that the flow coefficient be constant over the service life.

### OBJECT AND SUMMARY OF THE INVENTION

The object of the invention is to refine a fuel filter of the type defined at the outset such that it has a virtually constant flow coefficient over its service life.

For attaining this object it is therefore important that the flow coefficient inside the fuel filter be set sufficiently precisely. It is therefore proposed that a known fuel filter be refined such that the transitions of the outlet openings, particularly relative to the inner wall, not have sharp edges but instead have rounded places, and these rounded places can be produced by means of a known hydroerosive rounding process.

A substantial advantage of the invention is that the flow coefficient can be set precisely, since the outlet openings have rounded places toward the inner wall of the filter body that allow a nearly laminar flow inside the filter body. As a result, throttling inside the filter body because of turbulence that occurs, especially at edges, is avoided.

With the aid of the hydroerosive process (HE rounding process) known per se, these rounded places are produced, specifically in such a way that already during the production process, the flow coefficient of the filter body can be measured. In this hydroerosive process, a fluid that contains grinding bodies is pressed with pressure through the previously made outlet openings, causing the edges of the outlet openings to be rounded by being ground off, namely in the region of the transition from the inner wall of the filter body to the outlet opening.

By the above-described hydroerosive rounding process, any wear at the edges that might occur during use is produced in advance by the process so that the flow of fuel from the inlet opening to the outlet opening changes only slightly or not at all over the running life of the filter.

It has also been found that by employing the hydroerosive rounding process, the flow coefficient of the fuel filter is improved, so that high throughput rates can be attained with smaller outlet openings, or with only a few outlet openings.

A preferred embodiment advantageously provides that in a filter body, the outlet openings are first made by means of a laser drilling process. In a further ensuing machining process, hydroerosive rounding process is employed, and the flow coefficient is measured during the process.

Another advantage of the invention is that there is a damping system inside the fuel filter. In a preferred exemplary embodiment, this damping system is embodied such that star-shaped damping elements that suitably damp the various pressure pulses are located inside the fuel filter. The fuel filter itself furthermore has a corresponding damping property, since the diameter of the outlet openings is substantially less than that of the inlet opening.

### BRIEF DESCRIPTION OF THE DRAWINGS

The invention will be better understood and further objects and advantages thereof will become more apparent from the ensuing detailed description of a preferred embodiment taken in conjunction with the drawings, in which:

FIG. 1 is a perspective view of the fuel filter of the invention;

FIG. 2 is a side view, partly in section, of the fuel filter of the invention;

FIG. 3 is a front view of the fuel filter of FIG. 2; and

FIG. 4 is a section through the fuel filter of FIG. 2, taken along a line IV-IV.

### DESCRIPTION OF A PREFERRED EMBODIMENT

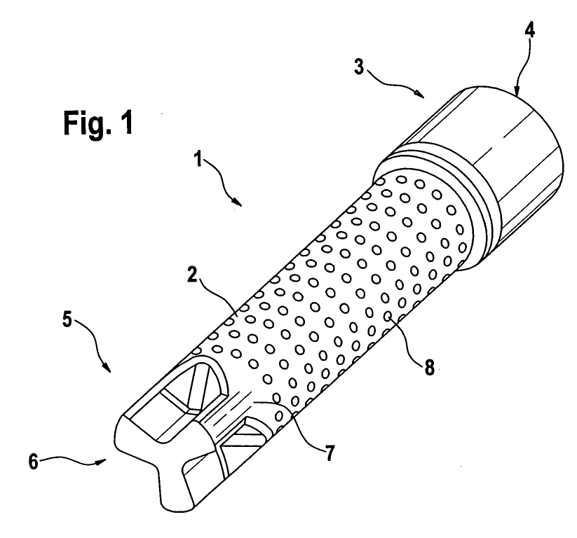

The fuel filter 1 in FIGS. 1 through 4 comprises a rodlike filter body 2, and on one end 3, the filter body 2 has an inlet opening 4. On its other end 5, a fixation element 6 is preferably provided, for fixing the filter body 2 inside a fuel injection device, not shown, in a manner fixed against relative rotation. On its circumference 7, a plurality of outlet openings 8, embodied as bores, are provided, preferably located at regular intervals. The outlet openings 8 are in fluidic contact with the hollow chamber 9 provided in the filter body 2.

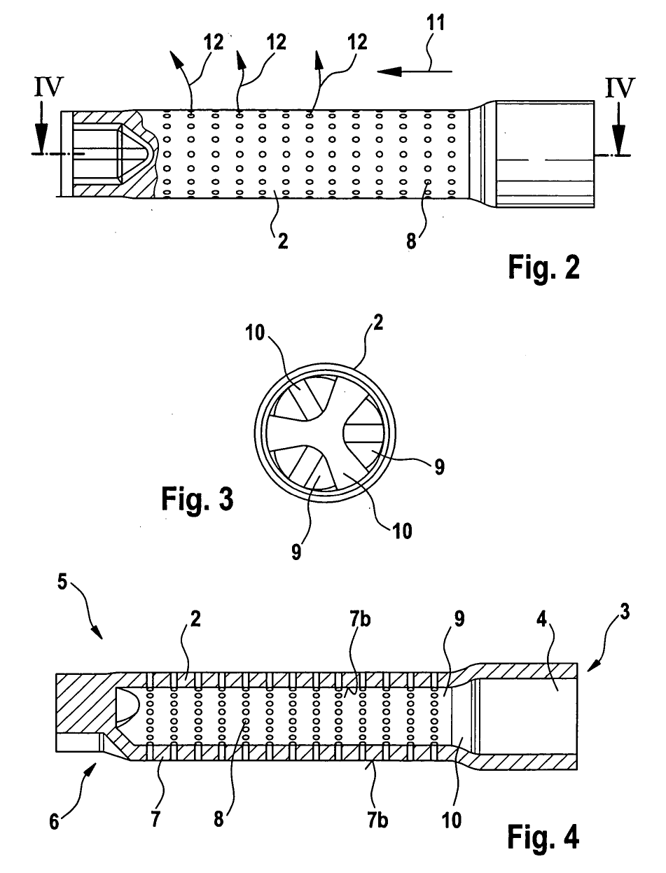

In the view shown in FIG. 3, at least one damping element 10 is located inside the hollow chamber 9 of the filter body 2; in the fluid direction (arrow 11 in FIG. 2), the damping element(s) forms an obstacle for the flow of the fuel, not identified here by reference numeral. The fuel that is made to oscillate strikes the damping element 10 directly, or strikes damping elements 10 located still farther downstream, and is accordingly decelerated. Immediately after the damping, or after a defined travel distance, the fuel emerges from the filter body 2 out of the outlet openings 8 in the direction of the arrow 12.

The outlet openings 8 shown in FIGS. 1 through 4 are drilled into the filter body 2 by means of a laser drilling process. To enable suitably setting the flow rate or pressure drop within one fuel injection, the outlet openings 8 are provided with a defined diameter.

According to the invention, it is provided that the rounded places of the outlet openings 8 (that is, the edges between the inner face 7b of the filter body 2 and the respective outlet opening 8, as shown in FIG. 4) be designed accordingly and machined by a so-called hydroerosive process (HE rounding process). It is thus assured that the outlet openings have rounded places in the defined regions. This prevents the formation of sharp edges.

The invention is not limited to the exemplary embodiment described. On the contrary, the invention extends to filter bodies whose edges, which are created in the region of the inner wall to the outlet opening, are rounded. In particular, the use of the hydroerosive process is proposed for this purpose.

The foregoing relates to a preferred exemplary embodiment of the invention, it being understood that other variants and embodiments thereof are possible within the spirit and scope of the invention, the latter being defined by the appended claims.

I claim:

1. A fuel filter comprising a rodlike filter body having a hollow chamber defining an inner surfaced of a wall of the filter body, the filter body being adapted to be introduced into an inlet conduit in a fuel injection device of a common rail system, the filter body having at least one inlet opening and at least one outlet opening, the at least one outlet opening extending from the hollow chamber through the wall of the filter body, and the outlet openings at the transitions of the outlet openings from the inner wall to the outlet opening are provided with a degree of rounding.

2. The fuel filter in accordance with claim 1, wherein the degree of rounding can be produced by means of hydroerosive rounding (HE rounding process).

3. The fuel filter in accordance with claim 1, further comprising at least one damping element inside the hollow chamber of filter body.

4. The fuel filter in accordance with claim 1, further comprising at least one damping element inside the hollow chamber of filter body.

5. A process for producing a fuel filter having a rodlike filter body which is introduced into an inlet conduit in a fuel injection device of a common rail system, the filter body having at least one inlet opening and at least one outlet opening, the process comprising rounding the outlet openings at the transitions of the outlet openings from the respective inner wall to the outlet opening by means of a hydroerosive rounding processes.

6. The use of a hydroerosive process for producing a fuel filter, comprising a rodlike filter body which is introduced into an inlet conduit in a fuel injection device of a common rail system, the filter body having at least one inlet opening and at least one outlet opening, wherein this process is employed for producing rounded places at outlet openings at the transitions of the outlet openings from an inner wall of the filter body to the outlet opening.
